(19) United States
(12) Patent Application Publication
(10) Pub. No.: US 2014/0126614 A1
(43) Pub. Date: May 8, 2014

(54) SYSTEM, METHOD, AND APPARATUS FOR DIGITAL PRE-EMPHASIS IN LOW POWER SERDES SYSTEMS

(71) Applicant: BROADCOM CORPORATION, Irvine, CA (US)

(72) Inventors: Hassan Maarefi, Irvine, CA (US); Siavash Fallahi, Newport Coast, CA (US)

(73) Assignee: BROADCOM CORPORATION, Irvine, CA (US)

(21) Appl. No.: 13/720,692

(22) Filed: Dec. 19, 2012

Related U.S. Application Data
(60) Provisional application No. 61/724,025, filed on Nov. 8, 2012.

(51) Int. Cl. H04B 1/40; H04B 1/04; H04B 1/62

(52) U.S. Cl. CPC H04B 1/40; H04B 1/62; H04B 1/0475
USPC 375/219; 375/285; 375/296

(57) ABSTRACT

A communication system is described that includes a transmitter to transmit data using one or more drivers. The drivers may drive the data in a manner that accords with pre-emphasis being selectively enabled or disabled for each driver. The pre-emphasis, when enabled, is applied by corresponding driver. The drivers may also be programmably selected and enabled or disabled. The transmitter also includes one or more driver selection circuits. The driver selection circuits may be configured to select one or more of the drivers to transmit the data, to selectively enable or disable pre-emphasis to be applied by each of the selected drivers, and to provide the data, or representations thereof, to the selected drivers.

### CROSS REFERENCE TO RELATED APPLICATIONS

This application claims the benefit of U.S. Provisional Application No. 61/724,025, filed on Nov. 8, 2012, which is incorporated by reference herein in its entirety.

### BACKGROUND

1. Technical Field

The subject matter described herein relates to communication systems, and in particular, to digital pre-emphasis in serializer/deserializer (SERDES) systems.

2. Background Art

Communication systems for transmitting data may transmit data from a transmitter to a receiver over a communication channel. One implementation of such a system is a SERDES system that takes a given number of data bits from a digital domain, serializes the data, and transmits the serial data to a receiver that deserializes it for another digital domain. SERDES data transmission implementations can be used in a wide range of communication systems and devices, such as mobile devices, desktop computers and servers, computer networks, and telecommunication networks.

Communication systems may transmit data over transmission media using pre-emphasis. Transmission media may act to attenuate high-frequency components of transmission signals, particularly when transmission length is increased. As such, the transmission media may act as a low-pass filter through which high data rate transmissions fail or become corrupted thus decreasing transmission bandwidth. To counteract the low-pass filtering effect, pre-emphasis amplifies the high-frequency components of the transmission signals. To accomplish this, pre-emphasis provides a transmitter with the ability to transmit data at a relatively higher voltage level when the data transitions from one value to another (i.e., when the frequency of data value transition(s) is high).

Previous solutions have relied on power- and area-intensive circuits to implement pre-emphasis. For example, some previous solutions use two drivers (one for data and one for pre-emphasis) whose separate, respective outputs are combined (e.g., pre-emphasis is added or subtracted from the data output level) in order to provide the desired output voltages for transmissions with pre-emphasis. As noted, however, such previous solutions are detrimental to circuit power consumption, as well as to circuit area and signal routing. That is, the use of two drivers and their associated signal routing requires additional space and current consumption within a transmitter. Furthermore, such previous solutions transmit data above a nominal voltage for data value transitions and below the nominal voltage for non-transitioning data values by virtue of their configurations. As such, the step-size for the application of pre-emphasis is double the pre-emphasis value for these previous solutions. Continued increases in data transmission rates and requirements for scalability in digital designs further complicate the problems associated with previous solutions noted above.

### BRIEF SUMMARY

Methods, systems, and apparatuses are described for transmitting data using pre-emphasis, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a portion of a transmitter in a communication system configured to transmit data using pre-emphasis, according to an exemplary embodiment.

FIG. 2 is a flowchart providing example steps for providing pre-emphasis to be applied by a driver for data transmission, according to another exemplary embodiment.

FIG. 3 is a block diagram of a portion of a transmitter in a communication system with a unit driver configured to transmit data using pre-emphasis, according to a further exemplary embodiment.

FIG. 4 is a flowchart providing example steps for providing pre-emphasis to be applied by a number of unit drivers for data transmission, according to an exemplary embodiment.

FIG. 5 is a circuit diagram of a portion of transmitter in a communication system with a unit driver configured to transmit data using pre-emphasis, according to an exemplary embodiment.

FIG. 6 is a signal diagram providing example data value transitions and corresponding voltage and gain based on pre-emphasis, according to an exemplary embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, references in the specification to “data unit(s)” refer to discrete data values of a data signal. For example, a data sequence of ‘110100’ comprises six (‘6’) data units. The term “data units” may also be used to define a data value per unit (or duration) of time. For example, a given data value per clock cycle (or a portion of a clock cycle) in a digital embodiment, or an analog signal value for a specified period of time, may each be referred to as a “data unit” herein.

Still further, terminology used herein to refer to logical high signals, logical low signals, and signals which are logical inverses of other signals is not intended to limit the actual quantitative value of a given signal. For example, depending upon the implementation, a value that corresponds to a one (‘1’) (logical high signal value) may be a voltage of 5V, 2.5V, 1.8V, etc., in an actual circuit. Similarly, a value that corresponds to a zero (‘0’) (logical low signal value) may be a voltage of 0V, 0.7V, a voltage less than the corresponding logic high voltage, etc., in an actual circuit implementation. Logical value representations, as described in embodiments herein, are not limited to digital implementations, but are also applicable to analog or mixed-signal designs.

Still further, the use herein of suffixes such as “_b”, “_n”, and/or “_” is intended to indicate an inverted or active low signal value. For example, for a given signal called “enable,” a corresponding signal called “enable_b” or “enable_n” refers to a logical inverse of the “enable” signal. That is, if “enable” has a value of logical one (‘ 1’) or “high,” the “enable_b” value would correspond to a logical zero (‘0’) or “low.”

Still further, terminology used herein such as “about,” “approximately,” and “substantially” have equivalent meanings and may be used interchangeably.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### Example Embodiments

The example embodiments described herein are provided for illustrative purposes, and are not limiting. The examples described herein may be adapted to various types of wired and wireless communications systems, computing systems, communication devices, and/or the like. Furthermore, additional structural and operational embodiments, including modifications/alterations, will become apparent to persons skilled in the relevant art(s) from the teachings herein.

In embodiments, SERDES communication systems may transmit data over a communication channel using a transmitter. The transmitter includes one or more drivers and one or more corresponding selection circuits. The selection circuit(s) selects and enables the driver(s) to drive the data over the communication channel and selectively enables or disables pre-emphasis to be applied by the driver(s).

The communication channel medium and/or the length of the communication channel may cause attenuation of the high-frequency components of the transmitted data signal. In an embodiment, the transmitter may transmit the data using the driver(s) and, for each driver, pre-emphasis may be selectively enabled or disabled such that attenuation of the transmitted data is reduced or effectively eliminated. Additionally, in embodiments, only the drivers selected and enabled to drive data are active in the transmitter circuit, and a subset of the selected drivers provides pre-emphasis. As such, the transmitter may select only the requisite number of drivers required to transmit the data at a desired amplitude and pre-emphasis. That is, because pre-emphasis is to be applied by a subset of the selected drivers, a single driver (i.e., a discrete driver unit) may transmit the data according to the selectively enabled or disabled pre-emphasis without the need for an additional driver (i.e., an additional driver unit). Such an implementation may allow for reduced power and area consumption for transmitters as compared to prior solutions, more accurate pre-emphasis over process, voltage and temperature variations, finer granularity for the application of pre-emphasis, as well as design scalability and portability.

Power- and area-efficient embodiments, such as those described herein, allow for transmission of data on communication channels using pre-emphasis. Various example embodiments are described in the following subsections. In particular, example transmitters are described, followed by an example operational embodiment for transmitting data using pre-emphasis. This is followed by a description of transmitters with one or more selectable unit drivers that apply selectively enabled or disabled pre-emphasis, then by an example operational embodiment for transmitting data using pre-emphasis with one or more unit drivers. Next follows descriptions of embodiments for transmitting data with pre-emphasis using a differential driver circuit. Subsequently, an example of data transmission and transition with respect to pre-emphasis and transmitter gain is described.

### Example Transmitter Embodiments

Communication systems may include various types of devices that include transmitters and receivers (and/or transmitter portions and receiver portions within transceivers) to communicate data between each other. Embodiments described herein may include inter-device and intra-device communication systems. For instance, the example embodiments described herein may be adapted to various types of mobile and non-mobile communications systems (including but not limited to, cellular networks, optical networks, local area network(s) (“LANs”), wireless LANs, Internet service providers (“ISPs”), switches and/or routers, etc.), computing systems (including but not limited to, servers, desktops, laptops, gaming systems, etc.), communication devices (including but not limited to, cellular phones, smart phones, etc.), and/or the like. Example embodiments can be incorporated into various types of communication systems, such as intra-computer data transmission structures (e.g., Peripheral Component Interconnect (PCI) Express bus), telecommunication networks, traditional and wireless local area networks (LANs and WLANs), wired and wireless point-to-point connections, optical data transmission systems (e.g., short haul, long haul, etc.), high-speed data transmission systems, coherent optical systems and/or other types of communication systems using SERDES. Furthermore, additional structural and operational embodiments, including modifications/alterations, will become apparent to persons skilled in the relevant art(s) from the teachings herein.

Increasing data transfer speeds and communication channel lengths in communications systems with SERDES provides design challenges due to attenuation of high-frequency components of data transmitted over transmission media, as well as circuit considerations such as power consumption, area, and routing. Preventing or managing this attenuation in turn causes circuit design difficulties. Data transmitters may use pre-emphasis to overcome attenuation, but previous pre-emphasis circuit solutions consume excessive power and require additional area and routing. For example, previous solutions use one driver for driving data and use an additional driver to provide pre-emphasis. The outputs of these two separate drivers are combined (e.g., using an adder/subtracter) to generate a signal to be transmitted.

Embodiments presented herein overcome problems with the attenuation of data transmissions in communication systems with SERDES for data transfer. The embodiments presented herein also overcome problems with power consumption, circuit area and routing utilization in prior solutions. Example embodiments are described in detail in the following section.

For instance, methods, systems, and apparatuses are provided for transmitting data in communication systems using pre-emphasis. In an example aspect, a transmitter is described that includes one or more drivers and one or more driver selection circuits. The one or more drivers are each configured to transmit data over a communication channel to a receiver. The one or more driver selection circuits each correspond to one of the one or more drivers. Each driver selection circuit is configured to select one or more of the drivers to transmit data, selectively enable or disable pre-emphasis to be applied by each of the selected drivers, and provide the data to the selected drivers.

In another example aspect, a method is disclosed. The example method is performed by a transmitter that is configurable to enable or disable pre-emphasis for transmitting data. The method includes selecting a driver to transmit data over a communication channel based on a driver selection signal. The method also includes selectively enabling or disabling pre-emphasis to be applied by the driver based on a pre-emphasis selection signal. The method further includes transmitting the data according to pre-emphasis being enabled or disabled from the driver over the communication channel.

In yet another example aspect, a differential driver circuit is described that includes a positive driver portion, a negative driver portion, a positive selector portion, and a negative selector portion. The positive driver portion is configured to transmit a first data value at a first output voltage or a second output voltage, where the second output voltage is based on pre-emphasis to be applied by the positive driver portion. The negative driver portion is configured to transmit a second data value at a third output voltage or a fourth output voltage, where the fourth output voltage is based on pre-emphasis to be applied by the negative driver portion. The third and fourth output voltages have a logical polarity that is the opposite of the first and second output voltage. The positive selector portion is coupled to the positive driver portion. The positive selector portion is configured to enable the positive driver portion and to selectively enable or disable pre-emphasis to be applied by the positive driver portion. The negative selector portion is coupled to the negative driver portion. The negative selector portion is configured to enable the negative driver portion and to selectively enable or disable pre-emphasis to be applied by the negative driver portion.

### Further Example Transmitter Embodiments

Transmitters in communication systems may be configured in various ways to transmit data according to applied pre-emphasis, in embodiments. For example, FIG. 1 shows a block diagram of a communication system 100, according to an embodiment. Communication system 100 includes a transmitter 102, a receiver 104, and a communication channel 106. Communication system 100 and each of the components included therein may include functionality beyond what is shown in FIG. 1, as would be apparent to persons skilled in relevant art(s). However, such additional functionality is not shown in FIG. 1 for the sake of brevity.

Transmitter 102 is configured to transmit data to receiver 104 over communication channel 106. Transmitter 102 includes one or more drivers 108₁-108_{N} and one or more corresponding driver selection circuits 110₁-110_{N}, where N is an integer greater than 1. Driver(s) 108₁-108_{N} may be connected together in series (e.g., cascaded drivers) to provide a single, combined data output to be driven over communication channel 106. Driver(s) 108₁-108_{N} and corresponding driver selection circuit(s) 110₁-110_{N} are respectively connected via one or more selection output connections 112₁-112_{N}, again where N is an integer greater than 1. That is, in embodiments, each driver selection circuit 110₁-110_{N} may be connected to a corresponding driver 108₁-108_{N} by a separate, respective selection output connection 112₁-112_{N} which may include one or more signal transmission lines. It is contemplated, however, that in other embodiments a given driver selection circuit (e.g., driver selection circuit 110₁) may be connected to more than one driver (e.g., driver 108₁ and 108₂). Each driver selection circuit 110₁-110_{N} receives data to be transmitted on a data input line 114 from one or more circuits (not shown) of communication system 100.

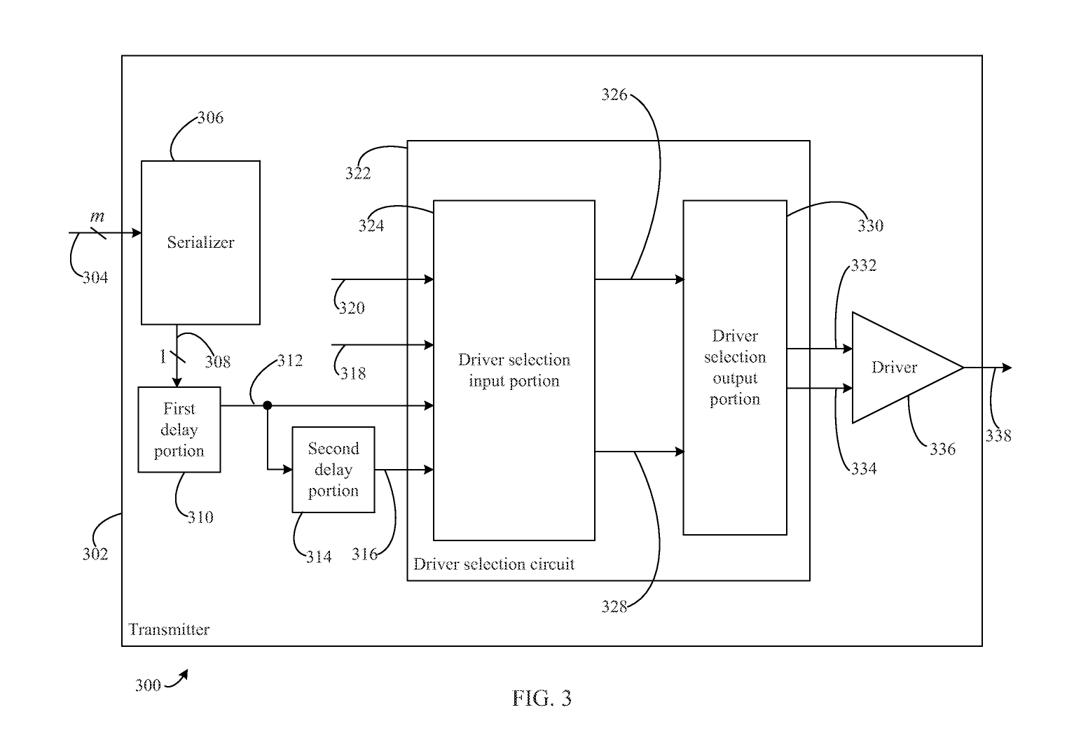

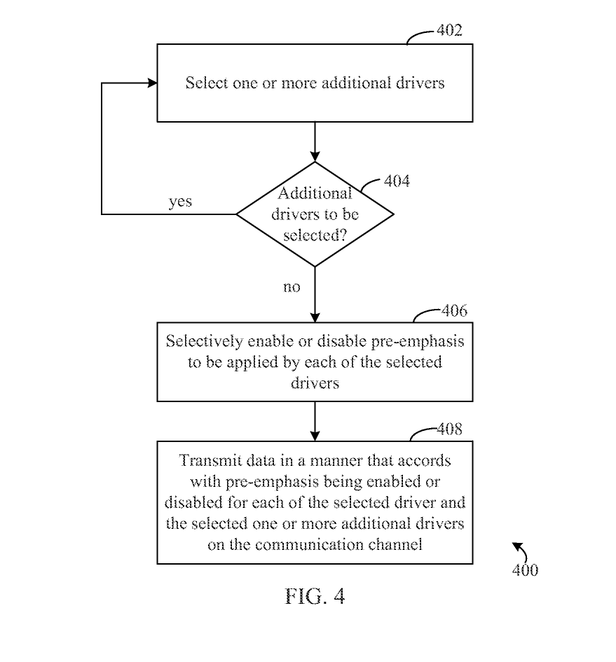

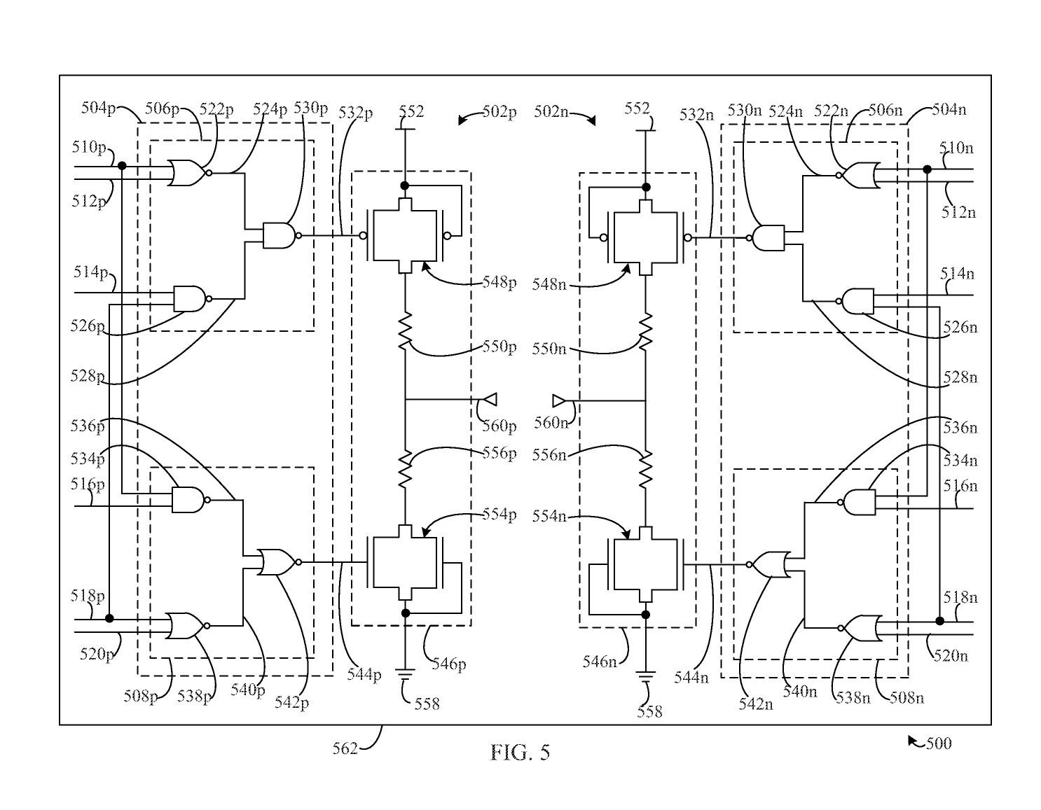

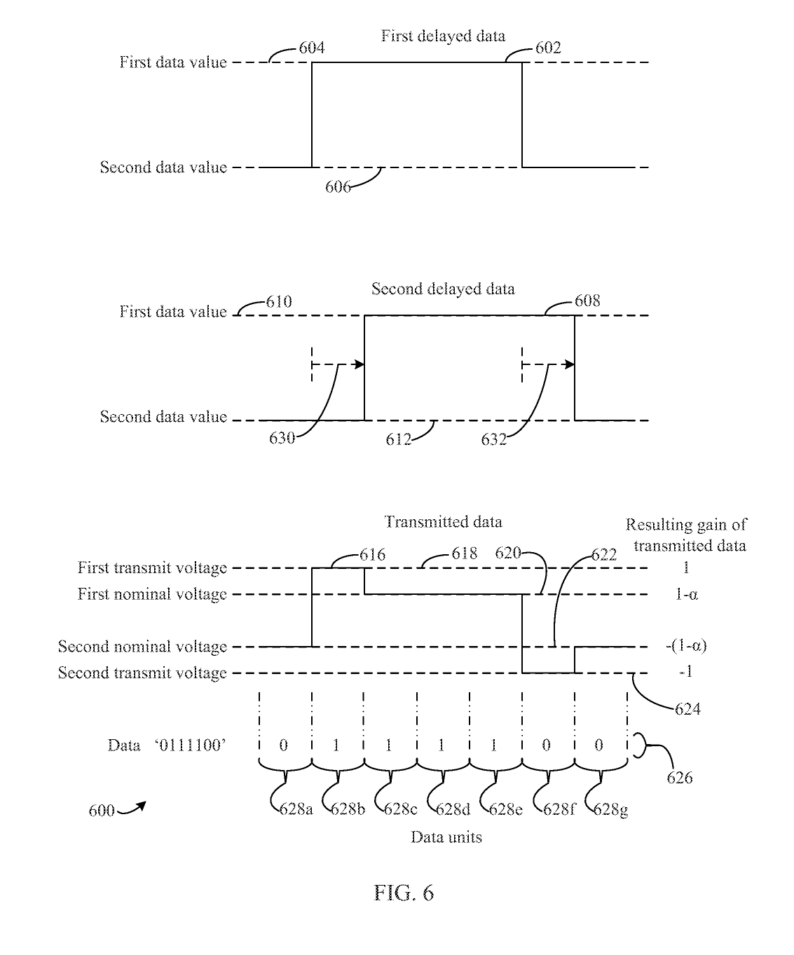

Each driver 108₁-108_{N} may be selected and enabled by its corresponding driver selection circuit 110₁-110_{N} using driver select lines (shown in FIGS. 3 and 5 and discussed in further detail below with respect to FIGS. 3 and 5). Each driver 108₁-108_{N} is configured to drive data at one or more voltage values. Each driver 108₁-108_{N} is also configured to drive data using pre-emphasis. The one or more voltage values are generated by each driver 108₁-108_{N} based on signals received from corresponding driver selection circuits 110₁-110_{N} on respective selection output connections 112₁-112_{N}. The pre-emphasis to be applied by each driver is selectively enabled or disabled by corresponding driver selection circuits 110₁-110_{N} (discussed in further detail below with respect to FIGS. 3 and 5). Selection output connections 112₁-112_{N} provide the data, or representations thereof, to drivers 108₁-108_{N} from their corresponding driver selection circuits 110₁-110_{N} which enables drivers 108₁-108_{N} to drive data at a given voltage value with or without pre-emphasis. That is, each driver 108₁-108_{N} applies pre-emphasis to a voltage value according to the enabling or disabling of pre-emphasis for that driver by its corresponding driver selection circuit 110₁-110_{N}. Thus, any number of drivers 108₁-108_{N} in transmitter 102 may be selected by corresponding driver selection circuits 110₁-110_{N} to drive data, and the pre-emphasis, if any, to be applied by each driver may be selectively enabled or disabled by corresponding driver selection circuits 110₁-110_{N}. As such, transmitter 102 may transmit data using one or more selected drivers 108₁-108_{N}, and each selected driver 108₁-108_{N} may apply, or may not apply, pre-emphasis when driving the data. Drivers 108₁-108_{N} not selected to drive data are disabled, do not consume power to drive data, and do not contribute to the driven data output of transmitter 102.

As noted above, transmitter 102 may be a transmitter or a transmitter portion of a transceiver. While not discussed in detail, it is contemplated that methods and components associated with transmitter 102 described with respect to FIG. 1 may be realized using a receiver (e.g., receiver 104), as would be as would be understood to persons skilled in relevant art(s) having the benefit of this disclosure. In some embodiments, any number of drivers 108₁-108_{N} (and corresponding driver selection circuits 110₁-110_{N}) may be included in communication system 100. For example, forty (‘40’) drivers 108₁-108_{N}, where N is 40, may be included in an example communication system 100, while some subset of the forty drivers 108₁-108_{N}, e.g., twenty-six (‘26’) drivers, may be used for actual data transmission with the remainder being used for testing and/or calibration. As described herein, each individual driver 108₁-108_{N} may be referred to as a unit driver, a discrete driver unit, and/or a “slice.” As such, example embodiments may include transmitters 102 with one or more slices. In embodiments with multiple slices, amplitude of the transmitted data may be determined by the number of driver 108₁-108_{N} slices selected, and the pre-emphasis applied in transmitting the data may be the aggregated pre-emphasis applied by each selected driver 108₁-108_{N} slice. While embodiments herein may be described in terms of the components and operation(s) of a single unit driver “slice,” it should be noted that the description of a single unit driver is equally applicable to additional unit drivers, as discussed in further detail below.

Communication system 100 and each of the elements included therein may be implemented in hardware, or a combination of hardware and software and/or firmware.

### Example Operational Embodiment

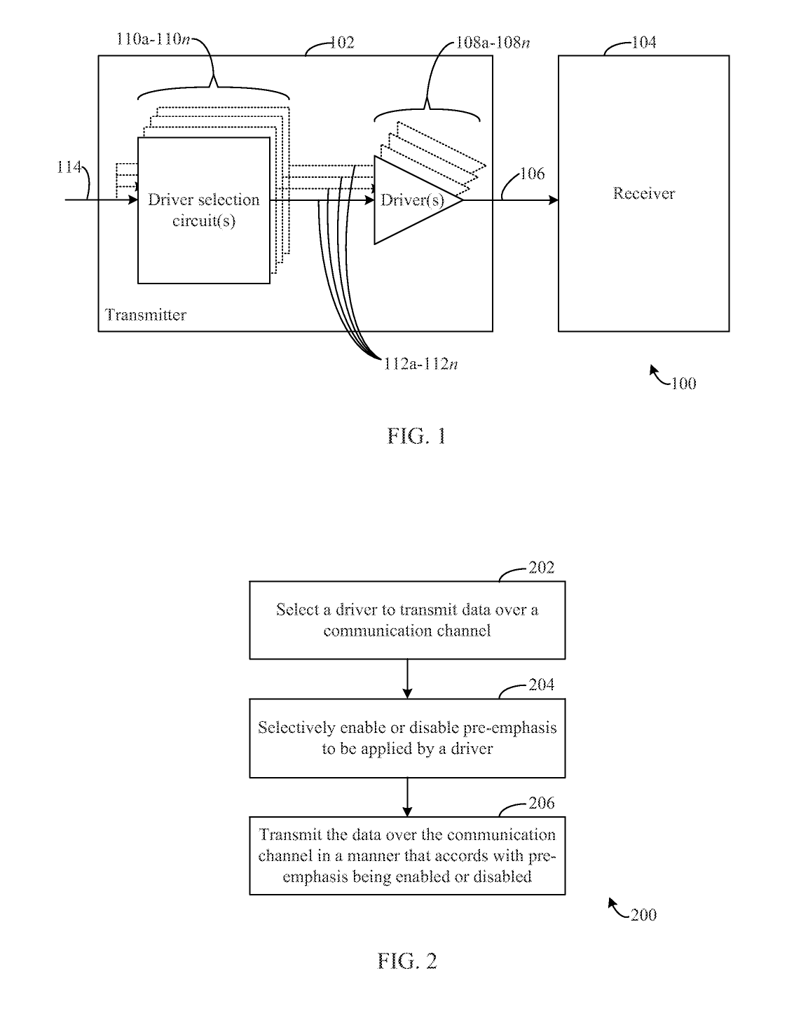

The above described communication system and transmitter may perform their functions in various ways, including as described above and as described in the present subsection. For example, FIG. 2 shows a flowchart 200 providing example steps for transmitting data using pre-emphasis, according to an exemplary embodiment. Communication system 100 and transmitter 102 of FIG. 1 may each operate according to flowchart 200, in an embodiment. Other structural and operational embodiments will be apparent to persons skilled in the relevant art(s) based on the discussion regarding flowchart 200. Flowchart 200 is described as follows.

Flowchart 200 may begin with step 202. In step 202, a driver may be selected to transmit data over a communication channel. The data may be transmitted to a receiver based upon the selected driver. For example, referring again to FIG. 1, a driver (e.g., driver 108₁) may be selected by a corresponding driver selection circuit (e.g., driver selection circuit 110₁). Corresponding driver selection circuit 110₁ may provide an indication of the selection to driver 108₁ via selection output connection 112₁. The selection of driver 108₁ enables driver 108₁ to drive the data.

In step 204, pre-emphasis to be applied by the selected driver may be selectively enabled or disabled. For example, a driver selection circuit (e.g., driver selection circuit 110₁) that corresponds to the selected driver (e.g., driver 108₁) may selectively enable or disable pre-emphasis to be applied by the selected driver 108₁ of transmitter 102. Corresponding driver selection circuit 110₁ may provide an indication of whether pre-emphasis is to be enabled or disabled to driver 108₁ via selection output connection 112₁. In some embodiments, the indication may be provided as one or more of the data and/or a representation(s) of the data.

In step 206, the data may be transmitted over the communication channel with pre-emphasis being applied if pre-emphasis is enabled and with pre-emphasis not being applied if pre-emphasis is disabled. For example, referring again to FIG. 1, the selected driver (e.g., driver 108₁) may drive the data to be transmitted over communication channel 106 to receiver 104. Driver 108₁ drives data in a manner that accords with pre-emphasis being enabled or disabled. If pre-emphasis is enabled for driver 108₁, pre-emphasis is applied by that driver. Conversely, if pre-emphasis is not enabled for driver 108₁, pre-emphasis is not applied by that driver. Further details regarding the application of pre-emphasis are discussed below with respect to FIG. 6.

In some example embodiments, one or more steps 202, 204, and/or 206 of flowchart 200 may not be performed. Moreover, steps in addition to or in lieu of steps 202, 204, and/or 206 may be performed. Further, in some example embodiments, one or more of steps 202, 204, and/or 206 may be performed out of order, in an alternate sequence, or partially (or completely) concurrently with other steps.

### Example Transmitter Embodiments with Data Delay

In the embodiments described above, the communication system included one or more drivers and one or more corresponding driver selection circuits used to select/enable the driver(s) and pre-emphasis to be applied at the driver(s). In further embodiments, the data provided to the driver selection circuits may be delayed. One or more representations of delayed data with different amounts of delay may be provided to the driver selection circuits. Such an implementation may be referred to as a two tap, finite impulse response (FIR) filter. In these further embodiments, the first and second taps may be used to provide the data and to determine the selective enablement or disablement of pre-emphasis (e.g., as described above with respect to FIG. 1).

For example, FIG. 3 shows a block diagram of a portion of a communication system 300, according to an example embodiment. Communication system 300 includes a transmitter 302. Transmitter 302 is a further embodiment of transmitter 102 shown in FIG. 1, in accordance with some embodiments described herein. Transmitter 302 includes a serializer 306, a first delay portion 310, a second delay portion 314, a driver selection circuit 322 and a driver 336. Driver selection circuit 322 comprises a driver selection input portion 324 and a driver selection output portion 330. Driver 336 is one embodiment of driver 108₁ shown in FIG. 1, in accordance with some embodiments described herein. Driver selection circuit 322 is one embodiment of driver selection circuit 110₁ shown in FIG. 1, in accordance with some embodiments described herein. Communication system 300 and transmitter 302 may include functionality further than that shown in FIG. 3, as would be apparent to persons skilled in relevant art(s). However, such additional functionality is not shown in FIG. 3 for the sake of brevity. The elements of communication system 300 and transmitter 302 are described as follows.

As shown in FIG. 3, communication system 300 includes an input data bus 304 that may be m-bits wide, where m is an integer that is greater than zero (‘0’). Transmitter 302 receives bussed data via input data bus 304. The bussed data on input data bus 304 is input into serializer 306. Serializer 306 serializes the bussed data and transmits the serial data (hereinafter, “data” or “the data”) to first delay portion 310 via 1-bit wide serial data line 308. First delay portion delays the data by an initial pre-determined time delay (a first delay) and transmits the data with the first delay to second delay portion 314 and to driver selection circuit 322 via a first delay line 312. Second delay portion 314 further delays the data with the first time delay by a subsequent pre-determined time delay and transmits the data with the initial and subsequent delays (together, a second delay) to driver selection circuit 322 via a second delay line 316. Driver selection circuit 322 also receives a driver select input via a driver select line 318 and a programmable pre-emphasis enable input value via a pre-emphasis enable line 320. According to some embodiments, first delay line 312, second delay line 316, driver select line 318, and pre-emphasis enable line 320 may each comprise more than one data line to provide, for example, their respective signals as described above as well as the logical inverse of their respective signals.

Driver selection input portion 324 of driver selection circuit 322 receives the data with the first delay via first delay line 312, the data with the second delay via second delay line 316, the driver select input via driver select line 318, and the programmable pre-emphasis enable input value via pre-emphasis enable line 320. Driver selection input portion 324 processes these received inputs and provides outputs to driver selection output portion 330. Driver selection input portion 324 provides the data, or a first representation thereof, to driver selection output portion 330 via first selection data line 326. The first representation of the data includes an indication of whether the driver has been selected and an indication of whether pre-emphasis is to be applied at the driver 336. Driver selection input portion 324 also provides a second representation of the data to driver selection output portion 330 via second selection data line 328. The second representation of the data includes an indication of whether the driver has been selected and an indication of whether pre-emphasis is to be applied at the driver 336. According to some embodiments, first and second selection data lines 326/328 may each comprise more than one data line to provide, for example, their respective signals as described above as well as the logical inverse of their respective signals. Driver selection output portion 330 processes the received data, or the first representation thereof, and the second representation of the data. Driver selection output portion 330 provides the processed data (or first representation thereof) to driver 336 on first selection output line 332, and the processed second representation of the data to driver 336 on second selection output line 334.

Driver 336 receives inputs via first and second selection output lines 332/334. Driver 336 drives the data out on driver output line 338. Driver 336 drives the data based on the received inputs on first and second selection output lines 332/334.

Still referring to FIG. 3, the components of example transmitter 302 are now described in further detail. For example, in some embodiments, serializer 306 may include one or more serializing portions (not shown) configured to serialize the bussed data on input data bus 304. The serializing portion(s) may be one or more multiplexors that are controlled by selection and/or clock signals (not shown) generated by communication system 300. In some embodiments, each of first delay portion 310 and/or second delay portion 314 may comprise a flip-flop, a latch, a register, and/or the like, such that the serialized data on serial data line 308 is provided at a first delay on first delay line 312 and at a second delay (the sum of the delay from first delay portion 310 and second delay portion 314) on second delay line 316. First delay portion 310 and second delay portion 314 may be comprised of the same or different delay elements and may provide the same or different amounts of time delay. It is also contemplated that first delay portion 310 and/or second delay portion 314 may be included in serializer 306 according to design considerations, and that such inclusion does not substantially affect the operation of these components. It is further contemplated that first delay portion 310 may provide zero additional delay to the data on serial data line 308. That is, first delay portion 310 may be characterized as only providing data propagation delay associated with serial data line 308 and first delay line 312.

In some embodiments, as noted above, first delay line 312, second delay line 316, driver select line 318, and pre-emphasis enable line 320 may each comprise more than one data line to provide, for example, their respective signals as described above as well as the logical inverse of their respective signals. In other embodiments, signals on first delay line 312, second delay line 316, driver select line 318, and pre-emphasis enable line 320 may be provided to various components within driver selection circuit 322 and/or driver selection input portion 324 which may invert these signals to provide the various components with logically inverted signal values as appropriate and as described in further detail below with respect to FIG. 5.

In some embodiments, driver select input portion 324 processes the received data, representations thereof, the pre-emphasis enable input value, the driver select input, and/or logically inverted signals related to these received signals. Driver select input portion 324 processes these signals, for example using digital circuits (e.g., combinatorial logic gates and elements), to combine the signals thereby reducing the total number of signals to be provided to the driver select output portion 330. The processing performed by driver select input portion 324 is based on design considerations for ultimately providing driver 336 with inputs such that driver 336 drives the data according to the data value and in a manner that accords with pre-emphasis being enabled or disabled.

In some embodiments, driver select output portion 330 further processes the processed data, representations thereof, the pre-emphasis enable input value, the driver select input, and/or logically inverted signals related to these received signals from driver select output portion 324. Driver select output portion 330 further processes the processed signals, for example using digital circuits (e.g., combinatorial logic gates and elements), to combine the signals thereby reducing the total number of signals to be provided to the driver 336. The processing performed by driver select output portion 330 is based on design considerations for ultimately providing driver 336 with inputs such that driver 336 drives the data according to the data value and according to pre-emphasis being selectively enabled or disabled.

Thus, according to some embodiments and as shown in FIG. 3, the data, representations thereof, the pre-emphasis enable input value, the driver select input, and/or logically inverted signals related to these received signals are reduced to two (‘2’) signals to be provided to driver 336 as inputs via first selection output line 332 and second selection output line 334.

In some embodiments, driver 336 drives the data according to the inputs received via first and second selection output lines 332/334. Driver 336 may drive the data at various voltages determined by driver components within driver 336, such as, but not limited to, sub-driver circuits, resistive elements, voltage dividers, transistors, etc. According to some embodiments, when pre-emphasis is selectively enabled to be applied by driver 336, driver 336 drives the data at one of four output voltages, as described in further detail below with respect to FIG. 6. In some embodiments, when pre-emphasis is selectively disabled and not to be applied by driver 336, driver 336 drives the data at one of two output voltages, as described in further detail below with respect to FIG. 6. For example, driver 336 may drive the data at a voltage “A” for a data value of one (‘1’) or at a voltage “B” for a data value of zero (‘0’) if pre-emphasis is not to be applied by driver 336. If pre-emphasis is enabled to be applied at driver 336, driver 336 may drive the data at a voltage “C” that is greater than voltage “A” for a data value transition from zero (‘0’) to one (‘1’), or at a voltage “D” that is less than voltage “B” for a data value transition from one (‘1’) to zero (‘0’) (e.g., respective data value sequences of ‘01’ or ‘10’). While pre-emphasis is enabled, driver 336 may drive the data at a voltage “A” for a data value of one (‘1’) or at a voltage “B” for a data value of zero (‘0’) when the data value does not transition (e.g., a data value sequence of ‘11’ or ‘00’). While the driving of the data is described above in the context of a digital circuit, it is also contemplated that the techniques described herein may be similarly applied to analog circuits and analog data transmissions, as would become apparent to persons skilled in the relevant art(s) from the teachings herein.

It is contemplated that while transmitter 302 of FIG. 3 is described above in terms of a driver “slice” (i.e., a single driver 336 and a single corresponding driver selection circuit 322), transmitter 302 may comprise more than one unit driver 336. For example, multiple, discrete unit drivers 336 and multiple corresponding driver selection circuits 322 may be included in transmitter 302 for some embodiments. Multiple drivers 336 may be cascaded to provide a single, effective driver output. For example, as similarly described above for FIG. 1, forty (‘40’) drivers 108₁-108_{N}, where N is 40, may be included in an example communication system 100, while some subset of the forty drivers 108₁-108_{N}, e.g., twenty-six (‘26’) of drivers 108₁-108_{N}, may be used for actual data transmission, with the remainder being used for testing and/or calibration.

### Example Multi-Driver Operational Embodiment

The above described communication systems and transmitters may perform their functions in various ways, including as described above and as described in the present subsection. For example, FIG. 4 shows a flowchart 400 providing example steps for transmitting data using multiple drivers and pre-emphasis, according to an exemplary embodiment. Communication system 100 and transmitter 102 of FIG. 1, and communication system 300 and transmitter 302 of FIG. 3, may each operate according to flowchart 400, in an embodiment. Other structural and operational embodiments will be apparent to persons skilled in the relevant art(s) based on the discussion regarding flowchart 400. Flowchart 400 is described as follows.

Flowchart 400 may be a further embodiment of flowchart 200 described above, in which multiple drivers are selected to drive data, and wherein each selected driver is selectively enabled or disabled to apply pre-emphasis. For example, steps 402 and 404 described below may be an extension of step 202 of flowchart 200. Similarly, steps 406 and 408 shown below may be respective extensions of steps 204 and 206 of flowchart 200.

Flowchart 400 may begin with step 402. In step 402, one or more additional drivers may be selected to transmit data over a communication channel. The data may be transmitted to a receiver based upon the selected driver. For example, referring again to FIG. 3, two or more drivers 336 may be selected by corresponding driver selection circuits 322. Corresponding driver selection circuits 322 may provide an indication of the selections to respective drivers 336 via respective first and second selection data lines 326/328. The selection of multiple drivers 336 enables each selected driver 336 to contribute to driving the data, as discussed with respect to FIGS. 1 and 3 above.

In step 404, it is determined if additional drivers are to be selected. If additional drivers (e.g., any of drivers 108₁-108_{N} or driver 336) are to be selected, the flowchart returns to step 402. If no additional drivers (e.g., any of drivers 108₁-108_{N} or driver 336) are to be selected the flowchart proceeds to step 406. It is contemplated that in some embodiments, selected drivers may be selected at the same time, substantially or partly in parallel, or one after the other.

In step 406, pre-emphasis to be applied by each of the selected drivers may be selectively enabled or disabled. For example, driver selection circuits 322 that correspond to the selected drivers 336 may selectively enable or disable pre-emphasis to be applied by each of the selected drivers 336 of transmitter 302. Corresponding driver selection circuits 322 may provide an indication of whether pre-emphasis is to be enabled or disabled to each selected driver 336 via respective first and second selection data lines 326/328. In some embodiments, the indications may be provided as one or more of the data and/or a representation(s) of the data.

In step 408, the data may be transmitted over the communication channel using the selected drivers, wherein each selected driver is selectively enabled or disabled to apply pre-emphasis. For example, referring again to FIG. 3, the selected drivers 336 may participate in driving the data over driver output line 338. Selected drivers 336 drive the data according to pre-emphasis being enabled or disabled for each selected driver 336. If pre-emphasis is enabled for a given selected driver 336, pre-emphasis is applied by that driver. Conversely, if pre-emphasis is not enabled for a given selected driver 336, pre-emphasis is not applied by that driver. In some embodiments, when multiple drivers 336 are selected to drive the data over driver output line 338, it is contemplated that a single driver output signal is transmitted over driver output line 338. Selected drivers (e.g., 108₁ and/or 336) may be organized in a cascaded fashion in the transmitter (e.g., 102 and/or 302 respectively). The aggregated resulting output of the driver cascade may be the overall driver output driven over driver output line 338. The voltage and pre-emphasis applied by each respective driver are thus effectively combined. Further details regarding the application of pre-emphasis are discussed below with respect to FIG. 6.

In some example embodiments, one or more steps 402, 404, 406, and/or 408 of flowchart 400 may not be performed. Moreover, steps in addition to or in lieu of steps 402, 404, 406, and/or 408 may be performed. Further, in some example embodiments, one or more of steps 402, 404, 406, and/or 408 may be performed out of order, in an alternate sequence, or partially (or completely) concurrently with other steps.

### Example Differential Transmitter Embodiments

In the embodiments described above, the communication system includes a transmitter with one or more drivers and one or more corresponding driver selection circuits used to select/enable the driver(s) and pre-emphasis to be applied at the driver(s). In further embodiments, the transmitter may include a differential driver circuit. The differential driver circuit may comprise two complementary sub-circuits, one of which drives a data signal (i.e., a positive sub-circuit denoted with a “p” suffix), the other of which drives an inverted representation of the data signal (i.e., a negative sub-circuit denoted with an “n” suffix). In these further embodiments, the differential driver circuit drives its data outputs according to the selective enablement or disablement of pre-emphasis, as described in the embodiments presented herein.

For example, FIG. 5 shows a circuit diagram of a portion of transmitter 500 in a communication system (e.g., communication system 100 and/or 300) with a differential driver circuit 562 configured to transmit data using pre-emphasis, according to an example embodiment. Transmitter portion 500 is a further embodiment of transmitter 102 shown in FIG. 1 and/or transmitter 302 shown in FIG. 3, in accordance with some embodiments described herein. Transmitter portion 500 includes differential driver circuit 562. Differential driver circuit 562 is a further embodiment of driver 108₁ and driver selection circuit 110₁ shown in FIG. 1, and/or driver 336 and driver selection circuit 322 shown in FIG. 3. Differential driver circuit 562 includes a positive sub-circuit 502p and a negative sub-circuit 502n. Positive sub-circuit 502p includes a positive driver portion 546p and a positive selector portion 504p. Negative sub-circuit 502n includes a negative driver portion 546n and a negative selector portion 504n. Transmitter portion 500 and differential driver circuit 562 may include functionality further than shown in FIG. 5, as would be apparent to persons skilled in relevant art(s). However, such additional functionality is not shown in FIG. 5 for the sake of brevity. The elements of transmitter portion 500 and differential driver circuit 562 are described as follows.

As shown in FIG. 5, positive sub-circuit 502p receives a plurality of inputs. In some embodiments, for example, positive sub-circuit 502p receives signals on a data_b input 510p, a driver-select_b input 512p, a pre-emphasis enable 514p, a driver-select input 516p, a delayed-data input 518p, and a pre-emphasis_b enable 520p.

The signal on data_b input 510p is an inverted representation of the data to be transmitted, the signal on driver-select_b input 512p is an inverted representation of a driver selection signal to enable positive sub-circuit 502p, and the signal on pre-emphasis enable 514p is a programmable enable to apply pre-emphasis by positive driver portion 546p.

The signal on driver-select input 516p is a representation of a driver selection signal to enable positive sub-circuit 502p, the signal on delayed-data input 518p is a representation of the data to be transmitted that is delayed with respect to the data on data_b input 510p, and the signal on pre-emphasis_b enable 520p is an inverted representation of the programmable enable signal on pre-emphasis enable 514p.

Positive selector portion 504p includes a first selector circuit 506p and a second selector circuit 508p. Positive selector portion 504p is configured to select and enable positive driver portion 546p and to selectively enable or disable pre-emphasis to be applied by positive driver portion 546p by combining or processing the input signals received at first selector circuit 506p and second selector circuit 508p.

First selector circuit 506p receives inputs on data_b input 510p and driver-select_b input 512p at a NOR gate 522p with an output line 524p, and receives inputs on pre-emphasis enable 514p and delayed-data input 518p at a NAND gate 526p with an output line 528p. The output signals on output lines 524p and 528p are received at a NAND gate 530p with an output line 532p. Second selector circuit 508p receives inputs on data_b input 510p and driver-select input 516p at a NAND gate 534p with an output line 536p, and receives inputs on delayed-data input 518p and pre-emphasis_b enable 520p at a NOR gate 538p with an output line 540p. The output signals on output lines 536p and 540p are received at a NOR gate 542p with an output line 544p. In alternate embodiments, it is contemplated that different circuits of combinatorial logic and/or the like may be used in place of, or in addition to, those described in this subsection as would be apparent to persons skilled in relevant art(s) having the benefit of this disclosure.

Positive driver portion 546p is configured to transmit a first data value at one of a first output voltage or a second output voltage, where the second output voltage is based on pre-emphasis to be applied by positive driver portion 546p.

Positive driver portion 546p includes a first subdriver 548p, a second subdriver 554p, a first voltage divider that includes a resistive element 550p and a resistive element 556p, and a transmit data line 560p. First subdriver 548p includes a pFET pair with the gate of one pFET connected to output line 532p and the gate of the other pFET connected to a voltage supply VDD 552. The two sources of the pFET pair of first subdriver 548p are connected to VDD 552, and the two drains of the pFET pair of first subdriver 548p are connected to a first terminal of resistive element 550p. The second terminal of resistive element 550p is connected to transmit data line 560p. When the gate connected to output line 532p is activated by a logic low signal on output line 532p, the pFET pair of first subdriver 548p turns on and provides a connection to VDD 552 thus providing a first voltage value to the first terminal of resistive element 550p.

Second subdriver 554p includes an nFET pair with the gate of one nFET connected to output line 544p and the gate of the other pFET connected to a voltage supply GND 558. The two sources of the nFET pair of second subdriver 554p are connected to GND 558, and the two drains of the nFET pair of second subdriver 554p are connected to a first terminal of resistive element 556p. The second terminal of resistive element 556p is connected to transmit data line 560p. When the gate connected to output line 544p is activated by a logic high signal on output line 544p, the nFET pair of second subdriver 554p turns on an provides a connection to GND 558 thus providing a second voltage value to the first terminal of resistive element 556p.

Accordingly, the first voltage divider (i.e., resistive elements 550p and 556p) provides the first and second output voltages at which the data is transmitted.

In some embodiments, resistive elements 550p and 556p may be resistors and/or the like. The resistance values of resistive elements 550p and 556p may be adjustable or programmable. The resistance values of resistive elements 550p and 556p may be, in some embodiments, any values whose sum is 50 ohms. In embodiments with multiple drivers selected to drive data (e.g., two or more “slices” of differential driver circuit 562), the values of all resistive elements 550p and 556p in the multiple selected drivers may provide an effective resistance of 50 ohms.

It should be noted that for illustrative clarity, some components of positive driver portion 502p (e.g., positive selector portion 504p, first selector circuit 506p, second selector circuit 508p, and positive driver portion 546p) are shown in FIG. 5 using dashed lines. This illustrative feature is present to aid in clarity and readability of positive driver portion 502p. The use of dashed lines is not intended to denote that any of the above components are optional unless explicitly stated herein. Further, it is contemplated that in alternative embodiments, components within positive selector portion 504p, first selector circuit 506p, second selector circuit 508p, and positive driver portion 546p may vary in composition and/or implementation such that the functions of positive selector portion 504p, first selector circuit 506p, second selector circuit 508p, and positive driver portion 546p may be performed as described herein.

Still referring to FIG. 5, negative sub-circuit 502n receives a plurality of inputs. In particular, negative sub-circuit 502n receives signals on a data input 510n, a driver-select_b input 512n, a pre-emphasis enable 514n, a driver-select input 516n, a delayed-data_b input 518n, and a pre-emphasis_b enable 520n.

The signal on data input 510n is the data to be transmitted or a representation thereof, the signal on driver-select_b input 512n is an inverted representation of a driver selection signal to enable negative sub-circuit 502n, and the signal on pre-emphasis enable 514n is a programmable enable to apply pre-emphasis by negative driver portion 546n.

The signal on driver-select input 516n is a representation of a driver selection signal to enable sub-circuit 502n, the signal on delayed-data_b input 518n is an inverted representation of the data to be transmitted that is delayed with respect to the data on data input 510n, and the signal on pre-emphasis_b enable 520n is an inverted representation of the programmable enable signal on pre-emphasis enable 514n.

Negative sub-circuit 502n includes a negative selector portion 504n. Negative selector portion 504n includes a third selector circuit 506n and a fourth selector circuit 508n. Negative selector portion 504n is configured to select and enable negative driver portion 546n and to selectively enable or disable pre-emphasis to be applied by negative driver portion 546n by combining or processing the input signals received at third selector circuit 506n and fourth selector circuit 508n.

Third selector circuit 506n receives inputs on data input 510n and driver-select_b input 512n at a NOR gate 522n with an output line 524n, and receives inputs on pre-emphasis enable 514n and delayed-data_b input 518n at a NAND gate 526n with an output line 528n. The output signals on output lines 524n and 528n are received at a NAND gate 530n with an output line 532n. Fourth selector circuit 508n receives inputs on data input 510n and driver-select input 516n at a NAND gate 534n with an output line 536n, and receives inputs on delayed-data_b input 518n and pre-emphasis_b enable 520n at a NOR gate 538n with an output line 540n. The output signals on output lines 536n and 540n are received at a NOR gate 542n with an output line 544n. In alternate embodiments, it is contemplated that different circuits of combinatorial logic and/or the like may be used in place of, or in addition to, those described in this subsection as would be apparent to persons skilled in relevant art(s) having the benefit of this disclosure.

Negative driver portion 546n is configured to transmit a second data value at one of a third output voltage or a fourth output voltage, where the fourth output voltage is based on pre-emphasis to be applied by the negative driver portion 546p.

Negative driver portion 546n includes a third subdriver 548n, a fourth subdriver 554n, a second voltage divider that includes a resistive element 550n and a resistive element 556n, and a transmit data line 560n. Third subdriver 548n includes a pFET pair with the gate of one pFET connected to output line 532n and the gate of the other pFET connected to a voltage supply VDD 552. The two sources of the pFET pair of third subdriver 548n are connected to VDD 552, and the two drains of the pFET pair of third subdriver 548n are connected to a first terminal of resistive element 550n. The second terminal of resistive element 550n is connected to transmit data line 560n. When the gate connected to output line 532n is activated by a logic low signal on output line 532n, the nFET pair of third subdriver 548n turns on an provides a connection to VDD 552 thus providing a third voltage value to the first terminal of resistive element 550n.

Fourth subdriver 554n includes an nFET pair with the gate of one nFET connected to output line 544n and the gate of the other pFET connected to a voltage supply GND 558. The two sources of the nFET pair of fourth subdriver 554n are connected to GND 558, and the two drains of the nFET pair of fourth subdriver 554n are connected to a first terminal of resistive element 556n. The second terminal of resistive element 556n is connected to transmit data line 560n. When the gate connected to output line 544n is activated by a logic high signal on output line 544n, the nFET pair of fourth subdriver 554n turns on an provides a connection to GND 558 thus providing a fourth voltage value to the first terminal of resistive element 556n.

Accordingly, the second voltage divider (i.e., resistive elements 550n and 556n) provides the third and fourth output voltages at which the data is transmitted.

In some embodiments, resistive elements 550n and 556n may be resistors and/or the like. The resistance values of resistive elements 550n and 556n may be adjustable or programmable. The resistance values of resistive elements 550n and 556n may be, in some embodiments, any values whose sum is 50 ohms. In embodiments with multiple drivers selected to drive data (e.g., two or more “slices” of differential driver circuit 562), the values of all resistive elements 550n and 556n in the multiple selected drivers may provide an effective resistance of 50 ohms.

It should be noted that for illustrative clarity, some components of negative driver portion 502n (e.g., negative selector portion 504n, third selector circuit 506n, fourth selector circuit 508n, and negative driver portion 546n) are shown in FIG. 5 using dashed lines. This illustrative feature is present to aid in clarity and readability of negative driver portion 502n. The use of dashed lines is not intended to denote that any of the above components are optional unless explicitly stated herein. Further, it is contemplated that in alternative embodiments, components within negative selector portion 504n, third selector circuit 506n, fourth selector circuit 508n, and negative driver portion 546n may vary in composition and/or implementation such that the functions of negative selector portion 504n, third selector circuit 506n, fourth selector circuit 508n, and negative driver portion 546n may be performed as described herein.

In some embodiments, VDD 552 may be a positive circuit voltage and GND 558 may be 0V (“zero volts”), a ground source, or another voltage that is less than VDD 552.

The embodiments described in this subsection, and with respect to FIG. 5, are configured to drive data in a manner that accords with pre-emphasis being selectively enabled or disabled for one or more drivers. The example circuits shown in FIG. 5 and its accompanying description are configured to this purpose. Further details regarding the transmission of data with respect to voltage levels according to applied pre-emphasis are discussed in the next subsection below.

### Example Output Gain and Pre-Emphasis Embodiments

In the embodiments described above, a transmitter may transmit data using one or more selected drivers in the transmitter at different voltages, wherein the selected drivers drive the data in a manner that accords with pre-emphasis being enabled or disabled. The data signal transmitted according the previously described embodiments may be described in terms of transmit voltages and applied gain, where the applied gain is based, at least in part, on pre-emphasis being selectively applied at the selected one or more drivers.

For example, FIG. 6 shows a signal diagram 600 providing example data value transitions and corresponding voltage and gain based on pre-emphasis. FIG. 6 includes an example waveform of a first delayed data signal 602, an example waveform of a second delayed data signal 608, and an example waveform of a transmitted data signal 616 when pre-emphasis is enabled. The example waveform of first delayed data signal 602, the example waveform of second delayed data signal 608, and the example waveform of transmitted data signal 616, while not specifically drawn to scale with respect to amplitude or time units, are drawn to be temporally linked with respect to each other as described below. Signal diagram 600 is shown as an idealized diagram and may, in practice, include signal nuances further than shown in FIG. 6, as would be apparent to persons skilled in relevant art(s). However, such additional functionality is not shown in FIG. 6 for the sake of brevity. The elements of signal diagram 600 are described as follows.

The example waveform of first delayed data signal 602 is now described. First delayed data signal 602 is a data signal, commensurate with data to be transmitted as described in the previous embodiments herein, which is delayed by a specified amount of time. For example, first delayed data signal 602 may be a signal representative of data to be transmitted that has been delayed by one clock period after passing through a flip-flop or register. Example embodiments of first and second delay elements and signal delay are described above with respect to FIG. 3. First delayed data signal 602 may comprise a first data value 604 and a second data value 606. In some embodiments, first data value 604 corresponds to a logic high (‘1’) value, and second data value 606 corresponds to a logic low (‘0’) value. As discussed herein, the logic high and logic low values may correspond to a voltage value in a communication system (e.g., communication systems 100 and/or 300) and/or in a transmitter (e.g., transmitter 102 and/or 302) or some portion thereof (e.g., transmitter portion 500). First delayed data signal 602 may make one or more transitions from first data value 604 to second data value 606 and from second data value 606 to first data value 604. First delayed data signal 602 may also remain at first data value 604 or second data value 606 for consecutive periods of time (i.e., consecutive data units of first delayed data signal 602 may be the same value).

Second delayed data signal 608 is now described. Second delayed data signal 608 is a data signal, commensurate with data to be transmitted as described in the previous embodiments herein, which is delayed by a specified amount of time that is greater than the delay of first delayed data signal 602. For example, second delayed data signal 608 may be a signal representative of data to be transmitted that has been delayed by two clock periods (e.g., delayed by a first clock period after passing through a first flip-flop or register, such as the delay element that delays first delayed clock signal 602, and delayed by a second clock period after passing through a second flip-flop or register). That is, as show in FIG. 6, second delayed data signal 608 may be additionally delayed as compared to first delayed data signal 602 as shown by arrow 630 at the rising data value transition and as shown by arrow 632 at the falling data value transition. Example embodiments of first and second delay elements and signal delay are described above with respect to FIG. 3.

Second delayed data signal 608 may comprise a first data value 610 and a second data value 612. In some embodiments, first data value 610 corresponds to a logic high (‘1’) value, and second data value 612 corresponds to a logic low (‘0’) value. As discussed herein, the logic high and logic low values may correspond to a voltage value in a communication system (e.g., communication system 100 and/or 300) and/or in a transmitter (e.g., transmitter 102 and/or 302) or some portion thereof (e.g., transmitter portion 500). In some embodiments, first data values 604 and 610 are equal or approximately equal, and second data values 606 and 612 are equal or approximately equal. Second delayed data signal 608 may make one or more transitions from first data value 610 to second data value 612 and from second data value 612 to first data value 610. Second delayed data signal 608 may also remain at first data value 610 or second data value 612 for consecutive periods of time (i.e., consecutive data units of second delayed data signal 608 may be the same value).

Transmitted data signal 616 is now described. The example waveform of transmitted data signal 616 shown in FIG. 6 depicts the resulting data transmission when pre-emphasis is enabled for one or more selected drivers as described in the embodiments above. Transmitted data signal 616 is described with respect to first delayed data signal 602, second delayed data signal 608, a first transmit voltage 618, a first nominal voltage 620, a second transmit voltage 624, and second nominal voltage 622. The voltage difference between first transmit voltage 618 and first nominal voltage 620 is denoted as α (“alpha”). Similarly, the difference between second transmit voltage 624 and second nominal voltage 622 is also a (“alpha”). The value of a corresponds to the total aggregated pre-emphasis that is applied by the drivers selected to drive data (e.g., 108₁, 336, and/or 500). For example, if twenty-six (‘26’) drivers are selected to drive data and ten (‘10’) of the selected drivers are selectively enabled to apply pre-emphasis, a will have a first value. If twenty-six (‘26’) drivers are selected to drive data and five (‘5’) of the selected drivers are selectively enabled to apply pre-emphasis, a will have a second value. The number of selected drivers to apply pre-emphasis is programmably selectable.

As noted above, the gain of the transmitted data is related to the pre-emphasis applied by the selected drivers which are selectively enabled to apply pre-emphasis. At first transmit voltage 618, the corresponding transmission data gain is ‘1’. At first nominal voltage 620, the corresponding transmission data gain is ‘1−α’. At second transmit voltage 624, the corresponding transmission data gain is ‘−(1−α)’. At second nominal voltage 622, the corresponding transmission data gain is ‘−1’. The difference between the respective nominal and transmit voltages may be referred to as a step size in some embodiments. The step size, as shown in FIG. 6, is equal to a.

In the example embodiment shown in FIG. 6, data 626 to be transmitted is the exemplary binary sequence ‘0111100’. Data 626 to be transmitted is comprised of data units 628a-628g, although in embodiments, data 626 may comprise any number of data units 628a-628n, where n is an integer value greater than 1. It should be noted that data 626 transmitted at first transmit voltage 618 and first nominal voltage 620 corresponds to a logic high (‘1’) value, and data 626 transmitted at second transmit voltage 624 and second nominal voltage 622 corresponds to a logic low (‘0’) value. That is, data units (e.g., 628b-628e) which are transmitted at first transmit voltage 618 and first nominal voltage 620 are logic high (‘1’), and data units (e.g., 628a and 628f-628g) transmitted at second transmit voltage 624 and second nominal voltage 622 are logic low (‘0’).

In some embodiments, according to pre-emphasis being applied by one or more drivers (e.g., drivers 108₁, 336, and/or 500) which are driving data 626, data 626 is transmitted at the following voltages. When the data value transitions from a logic low (‘0’) to a logic high (‘1’), the data value, such as data unit 628b, is transmitted at first transmit voltage 618 with a gain of ‘1’. When the data value transitions from a logic high (‘1’) to a logic low (‘0’), the data value, such as data unit 628f, is transmitted at second transmit voltage 624 with a gain of ‘−1’. When the data value (e.g., at data unit 628c) is logic high (‘1’) remains unchanged from the previous data value (e.g., from data unit 628b to data unit 628c), the data value is transmitted at first nominal voltage 620 with a gain of ‘1−α’. When the data value (e.g., at data unit 628g) is logic low (‘0’) remains unchanged from the previous data value (e.g., from data unit 628f to data unit 628g), the data value is transmitted at second nominal voltage 622 with a gain of ‘−(1−α)’.

It should be noted that when pre-emphasis is selectively disabled for all drivers, the data 626 that is transmitted may be transmitted at one of the first transmit voltage 618 or the first nominal voltage 620 for a logic high data unit (e.g., 628b-628e), and may be transmitted at one of the second transmit voltage 624 or the second nominal voltage 622 for a logic low data unit (e.g., 628a and 628f-628g). That is, in some embodiments, if pre-emphasis is disabled for all drivers, data 626 may be transmitted one specified voltage for a logic high data unit and at another specified voltage for a logic low data unit without a positive (or negative) step size increase (or decrease) as with pre-emphasis enabled.

### Further Example Embodiments and Advantages

The embodiments described herein enable transmission of data according to pre-emphasis to be applied by one or more drivers being selectively enabled or disabled. Such embodiments may be implemented in circuits that have less power consumption, less circuit area and routing, as well more scalability. The embodiments described herein also allow for transmitter circuits that include fewer discrete driver elements. The application of pre-emphasis for any given driver is programmable, and the number of drivers selected to drive the data is selectable and configurable. Embodiments support communication systems that include data transmission across a variety of platforms and communication protocols.

It will be recognized that the systems, their respective components, and/or the techniques described herein may be implemented in hardware, software, firmware, or any combination thereof, and/or may be implemented as hardware logic/electrical circuitry.

The disclosed technologies can be put into practice using software, firmware, and/or hardware implementations other than those described herein. Any software, firmware, and hardware implementations suitable for performing the functions described herein can be used.

### CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A transmitter, comprising:
one or more drivers each configured to transmit data over a communication channel to a receiver, and
one or more driver selection circuits each corresponding to one of the one or more drivers and each configured to
select at least one of the one or more drivers to transmit the data,
selectively enable or disable pre-emphasis to be applied by each of the at least one of the one or more drivers, and
provide a representation of the data to the at least one of the one or more drivers.

2. The transmitter of claim 1, wherein each of the driver selection circuits includes at least one of
a driver selection input portion configured to
receive an indication that the at least one of the one or more drivers is to be enabled, and
receive an indication that pre-emphasis is to be applied by the at least one of the one or more drivers; and
a driver selection output portion configured to provide the representation of the data and the indication that pre-emphasis is to be applied to the at least one of the one or more drivers;
wherein selectively enabling or disabling is based on a programmable pre-emphasis value.

3. The transmitter of claim 1, wherein each of the one or more drivers includes a first voltage provider circuit, the first voltage provider circuit configured to provide a first driver voltage based on the provided representation of the data, and
a second voltage provider circuit, the second voltage provider circuit configured to provide a second driver voltage based on the provided representation of the data;
wherein each of the one or more drivers is configured to transmit the data at a voltage level based on the respective first and second driver voltages of each respective driver.

4. The transmitter of claim 1, further comprising a serializer configured to convert the data to a serial format.

5. The transmitter of claim 4, further comprising a delay circuit configured to:
receive the data in serial format from the serializer; and
provide the data to the driver selection circuit based on at least one time delay.

6. The transmitter of claim 5, wherein the delay circuit comprises:
a first delay portion configured to provide the data to the driver selection circuit with a first delay; and
a second delay portion configured to provide the data to the driver selection circuit with a second delay;
wherein the second delay is greater than the first delay, and wherein the pre-emphasis to be applied is based on the data provided to the driver selection circuit with the second delay.

7. The transmitter of claim 1, wherein each of the one or more drivers is a differential signal driver that includes a positive driver portion and a negative driver portion.

8. The transmitter of claim 1, comprising a plurality of drivers and a plurality of respective, corresponding driver selection circuits.

9. A method, comprising:
selecting a driver to transmit data over a communication channel based on a driver selection signal;
selectively enabling or disabling pre-emphasis to be applied by the driver based on a pre-emphasis selection signal; and
transmitting the data according to pre-emphasis being enabled or disabled from the driver over the communication channel.

10. The method of claim 9, further comprising:
providing a first representation of the data to the driver at a first predetermined delay; and
providing a second representation of the data to the driver at a second predetermined delay that is greater than the first predetermined delay;
wherein, transmitting the data according to the pre-emphasis being enabled or disabled is based on the first and the second provided representations of the data.

11. The method of claim 9, wherein:
selecting the driver includes selecting one or more additional drivers to transmit the data over the communication channel based on one or more additional, respective driver selection signals;
selectively enabling or disabling pre-emphasis to be applied by the driver includes selectively enabling or disabling pre-emphasis to be applied by each of the selected one or more additional drivers based on one or more additional, respective pre-emphasis selection signals; and
transmitting the data according to pre-emphasis being enabled or disabled includes transmitting the data according to pre-emphasis being enabled or disabled for each of the selected driver and the selected one or more additional drivers over the communication channel.

12. The method of claim 9, wherein selecting the driver includes
receiving the driver selection signal for the driver, the driver selection signal indicating that the driver is to be selected and enabled, and
enabling the driver in response to receiving the driver selection signal; and
wherein selectively enabling or disabling pre-emphasis to be applied by the driver includes
receiving the pre-emphasis indication for the selected driver, and
providing a pre-emphasis indication to the selected driver in response to the pre-emphasis indication.

13. The method of claim 9, wherein the driver is a differential signal driver, and wherein transmitting the data includes transmitting using differential signaling.

14. The method of claim 9, wherein when pre-emphasis is disabled, the driver transmits the data at one or more of a first nominal voltage corresponding to a first data value and a second nominal voltage corresponding to a second data value.

15. The method of claim 14, wherein when pre-emphasis is enabled,
the driver transmits the data at a first transmit voltage that is greater than the first nominal voltage, based on pre-emphasis being enabled, when the data transitions to the first data value from the second data value, and
the driver transmits the data at a second transmit voltage that is less than the second nominal voltage, based on pre-emphasis being enabled, when the data transitions from the first data value to the second data value.

16. The method of claim 15, wherein the driver transmits the data at the first nominal voltage when the data is transmitted at the first data value for two or more consecutive data units,
wherein the driver transmits the data at the second nominal voltage when the data is transmitted at the second data value for two or more consecutive data units, and
wherein the first nominal voltage is less than the first transmit voltage by a value that is about equal to the applied pre-emphasis, and the second nominal voltage is greater than the second transmit voltage by a value that is about equal to the applied pre-emphasis.

17. A differential driver circuit, comprising:
a positive driver portion configured to transmit a first data value at one of a first output voltage or a second output voltage, the second output voltage being based on pre-emphasis to be applied by the positive driver portion;
a negative driver portion configured to transmit a second data value at one of a third output voltage or a fourth output voltage, the fourth output voltage being based on pre-emphasis to be applied by the negative driver portion, each of the third and the fourth output voltages having a logical polarity that is opposite the first and the second output voltage;
a positive selector portion coupled to the positive driver portion, the positive selector portion configured to select and enable the positive driver portion and to selectively enable or disable pre-emphasis to be applied by the positive driver portion; and
a negative selector portion coupled to the negative driver portion, the negative selector portion configured to select and enable the negative driver portion and to selectively enable or disable pre-emphasis to be applied by the negative driver portion.

18. The differential driver circuit of claim 17, wherein the positive driver portion includes
a first subdriver configured to provide a first voltage value,
a second subdriver configured to provide a second voltage value, and
a first voltage divider configured to provide the first and second output voltages based on the first voltage value and the second voltage value; and
wherein the negative driver portion includes
a third subdriver configured to provide a third voltage value,
a fourth subdriver configured to provide a fourth voltage value, and
a second voltage divider configured to provide the third and fourth output voltages
based on the third voltage value and the fourth voltage value.

19. The differential driver circuit of claim 18, wherein the positive selector portion includes
a first selector circuit configured to provide a first representation of the first data value and an indication of pre-emphasis being selectively enabled or selectively disabled to the first subdriver, and
a second selector circuit configured to provide a second representation of the first data value and the indication of pre-emphasis being selectively enabled or selectively disabled to the second subdriver; and
wherein the negative selector portion includes
a third selector circuit configured to provide a first representation of the second data value and the indication of pre-emphasis being selectively enabled or selectively disabled to the third subdriver, and
a fourth selector circuit configured to provide a second representation of the second data value and the indication of pre-emphasis being selectively enabled or selectively disabled to the fourth subdriver.

20. The differential driver circuit of claim 17, wherein selectively enabling or selectively disabling pre-emphasis is programmably selectable, and
wherein pre-emphasis is applied by the positive driver portion and by the negative driver portion based on a pre-emphasis enable signal.
